(19) United States
(12) Patent Application Publication
(10) Pub. No.: US 2024/0122087 A1
(43) Pub. Date: Apr. 18, 2024

(54) SYSTEM AND METHOD FOR CONTROLLING THE OPERATION OF A TILLAGE IMPLEMENT

(71) Applicant: CNH Industrial America LLC, New Holland, PA (US)

(72) Inventor: Brittany Schroeder, Bunker Hill, IN (US)

(21) Appl. No.: 17/968,192

(22) Filed: Oct. 18, 2022

(51) Int. Cl. A01B 33/02; A01B 33/12; A01B 49/02

(52) U.S. Cl. CPC A01B 33/024; A01B 33/12; A01B 49/027

(57) ABSTRACT

A tillage implement includes a computing system configured to determine a field characteristic within a first portion of the field based on data generated by a first sensor. Furthermore, the computing system is configured to determine the field characteristic within a second portion of the field based on the data generated by a second sensor. Additionally, the computing system is configured to control the operation of a first tillage tool supported on a first frame section of the tillage implement based on the determined field characteristic within the first portion of the field and independently of the second tillage tool supported on a second frame section. Moreover, the computing system is configured to control the operation of the second tillage tool based on the determined field characteristic within the second portion of the field and independently of the first tillage tool.

### FIELD OF THE INVENTION

The present disclosure generally relates to tillage implements and, more particularly, to systems and methods for controlling the operation of a tillage implement.

### BACKGROUND OF THE INVENTION

It is well known that, to attain the best agricultural performance from a field, a farmer must cultivate the soil, typically through a tillage operation. Modern farmers perform tillage operations by pulling a tillage implement behind an agricultural work vehicle, such as a tractor. In general, tillage implements include ground-engaging tillage tools, such as shanks, disks, and/or the like, supported on its frame. Each ground-engaging tillage tool, in turn, is configured to be moved relative to the soil within the field as the tillage implement travels across the field. Such movement of the ground-engaging tillage tools loosens and/or otherwise agitates the soil to prepare the field for subsequent planting operations.

As a tillage implement travels across a field to perform a tillage operation, the tillage implement may encounter varying field conditions. In this respect, systems for controlling or otherwise adjusting the operation of a tillage implement during a tillage operation have been developed. While such systems work well, further improvements are needed.

Accordingly, an improved system and method for controlling the operation of a tillage implement would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a tillage implement. The tillage implement includes a frame extending in a lateral direction between a first side of the frame and a second side of the frame, with the frame including a first frame section configured to be moved across a first portion of a field. The frame further includes a second frame section spaced apart from the first frame section in the lateral direction, with the second frame section configured to be moved across a second portion of the field. Furthermore, the tillage implement includes a first tillage tool supported on the first frame section and a second tillage tool supported on the second frame section. Additionally, the tillage implement includes a first sensor configured to generate data indicative of a field characteristic within the first portion of the field and a second sensor configured to generate data indicative of the field characteristic within the second portion of the field. Moreover, the tillage implement includes a computing system communicatively coupled to the first sensor and the second sensor. In this respect, the computing system is configured to determine the field characteristic within the first portion of the field based on the data generated by the first sensor and determine the field characteristic within the second portion of the field based on the data generated by the second sensor. In addition, the computing system is configured to control an operation of the first tillage tool based on the determined field characteristic within the first portion of the field and independently of the second tillage tool. Furthermore, the computing system is configured to control an operation of the second tillage tool based on the determined field characteristic within the second portion of the field and independently of the first tillage tool.

In another aspect, the present subject matter is directed to a system for controlling an operation of a tillage implement. The system including a tillage implement frame extending in a lateral direction between a first side of the tillage implement frame and a second side of the tillage implement frame, with the frame including a first tillage implement frame section configured to be moved across a first portion of a field The tillage implement frame further includes a second tillage implement frame section spaced apart from the first tillage implement frame section in the lateral direction, with the second tillage implement frame section configured to be moved across a second portion of the field. Additionally, the system includes a first tillage tool supported on the first tillage implement frame section and a second tillage tool supported on the second tillage implement frame section. Moreover, the system includes a first sensor configured to generate data indicative of a field characteristic within the first portion of the field and a second sensor configured to generate data indicative of the field characteristic within the second portion of the field. In addition, the system includes a computing system communicatively coupled to the first sensor and the second sensor. In this respect, the computing system configured to determine the field characteristic within the first portion of the field based on the data generated by the first sensor and determine the field characteristic within the second portion of the field based on the data generated by the second sensor. Furthermore, the computing system is configured to control an operation of the first tillage tool based on the determined field characteristic within the first portion of the field and independently of the second tillage tool. Additionally, the computing system is configured to control an operation of the second tillage tool based on the determined field characteristic within the second portion of the field and independently of the first tillage tool.

In a further aspect, the present subject matter is directed to a method for controlling an operation of a tillage implement. The tillage implement, in turn, includes a first tillage implement frame section configured to be moved across a first portion of a field and a first tillage tool supported on the first tillage implement frame section. Moreover, the tillage implement includes a second tillage implement frame section configured to be moved across a second portion of the field and a second tillage tool supported on the second tillage implement frame section. The method includes receiving, with a computing system, first sensor data indicative of a field characteristic within the first portion of the field. In addition, the method includes receiving, with the computing system, second sensor data indicative of the field characteristic within the second portion of the field. Furthermore, the method includes determining, with the computing system, the field characteristic within the first portion of the field based on the received first sensor data. Additionally, the method includes determining, with the computing system, the field characteristic within the second portion of the field based on the received second sensor data. Moreover, the method includes controlling, with the computing system, an operation of the first tillage tool based on the determined field characteristic within the first portion of the field and independently of the second tillage tool. In addition, the method includes controlling, with the computing system, an operation of the second tillage tool based on the determined field characteristic within the second portion of the field and independently of the first tillage tool.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates an isometric view of one embodiment of a tillage implement in accordance with aspects of the present subject matter;

FIG. 2 illustrates a schematic, top-down view of the tillage implement shown in FIG. 1;

FIG. 3 illustrates a schematic view of one embodiment of a system for controlling the operation of a tillage implement in accordance with aspects of the present subject matter;

FIG. 4 illustrates a flow diagram providing one embodiment of control logic for controlling the operation of a tillage implement in accordance with aspects of the present subject matter; and

FIG. 5 illustrates a flow diagram of one embodiment of a method for controlling the operation of a tillage implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system and a method for controlling the operation of a tillage implement. As will be described below, the tillage implement includes a frame having a first frame portion configured to be moved across a first portion of the field and a second frame portion configured to be moved across a second portion of the field. One or more first tillage tools (e.g., a first shank(s), a first basket assembly(ies), etc.) are supported on the first frame section. Similarly, one or more second tillage tools (e.g., a second shank(s), a second basket assembly(ies), etc.) are supported on the second frame section.

A computing system is configured to independently control the operation of the first and second tillage tools. Specifically, in several embodiments, the computing system is configured to receive first sensor data indicative of a field characteristic within the first portion of the field and second sensor data indicative of the field characteristic within the second portion of the field. For example, the field characteristic may be the soil moisture content, the soil type, the soil texture, the presence of a subsurface soil compaction layer, and/or the like. Furthermore, the computing system is configured to determine the field characteristic within the first and second portions of the field based on the received first and second sensor data, respectively. Thereafter, the computing system is configured to control the operation of the first tillage tool(s) based on the determined field characteristic within the first portion of the field and independently of the second tillage tool(s). Additionally, the computing system is configured to control the operation of the second tillage tool(s) based on the determined field characteristic within the second portion of the field and independently of the first tillage tool(s). For example, the computing system may initiate independent adjustments to the penetration depths of and/or the forces being applied to the first and second tillage tool(s) based on the field characteristic within the first and second portions of the field, respectively.

Independently controlling the operation of the first and second tillage tools based on the field characteristic within the first and second portions of the field, respectively, improves the operation of the tillage implement. More specifically, the widths of tillage implements have grown dramatically over the years. In this respect, as a tillage implement travels across a field, the conditions of the field may vary across its width. As such, the first tillage tool(s) supported on the first frame section may encounter different field conditions than the second tillage tool(s) supported on the second frame section. As described above, the disclosed system and method independently control the first tillage tool(s) based on the specific field conditions that will be encountered by the first tillage tool(s) and the second tillage tool(s) based on the specific field conditions that will be encountered by second tillage tool(s). Thus, the disclosed system and method allow the operating parameters of each group of tools on the tillage implement to be adjusted across the width of the implement based on the specific field conditions that will be encountered by those tools. Accordingly, the disclosed system and method provide for improved control of the tillage implement, thereby improving the quality of the tillage operation being performed.

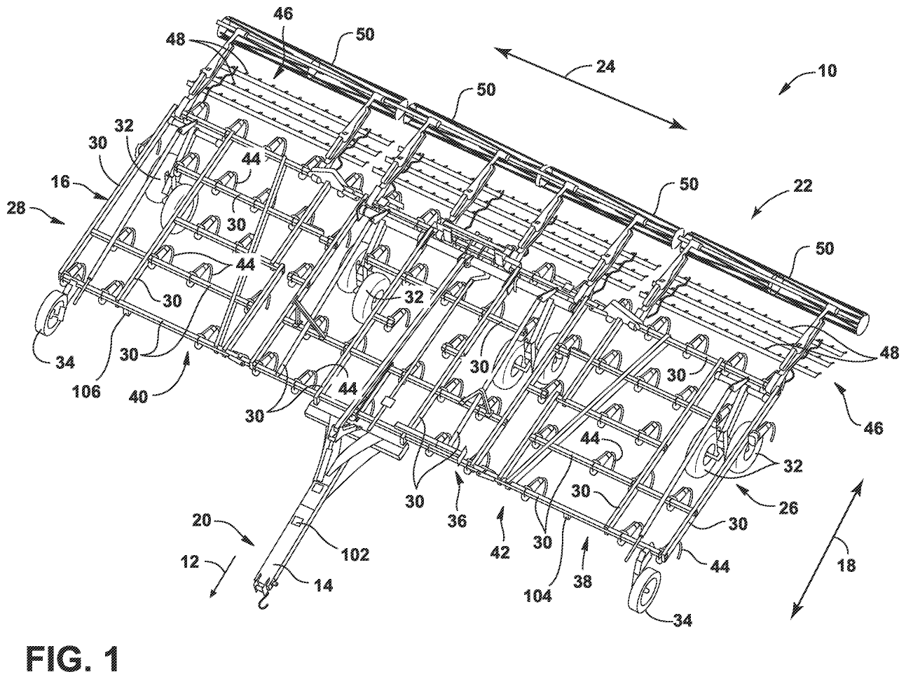

Referring now to the drawings, FIG. 1 illustrates an isometric view of one embodiment of a tillage implement 10 in accordance with aspects of the present subject matter. In general, the tillage implement 10 is configured to be towed or otherwise moved across a field in a direction of travel 12 by a suitable work vehicle (not shown), such as an agricultural tractor.

In the illustrated embodiment, the tillage implement 10 is configured as a field cultivator. However, in alternative embodiments, the tillage implement 10 may be configured as any other suitable type of implement configured to perform a tillage operation on a field, such as a disk ripper, a disk harrow, or the like.

As shown, the tillage implement 10 includes a tillage implement frame 16, which may be coupled to the work vehicle via a tow bar 14. In general, the tillage implement frame 16 extends in a longitudinal direction 18 between a forward end 20 and an aft end 22. The frame 16 also extends in a lateral direction 24 between a first side 26 and a second side 28. As such, the lateral direction 24 generally extends orthogonally to the longitudinal direction 18. Moreover, the tillage implement frame 16 generally includes a plurality of structural frame members 30, such as beams, bars, and/or the like, configured to support or couple to a plurality of components. Additionally, a plurality of wheels may be coupled to the tillage implement frame 16, such as a set of centrally located wheels 32 and a set of front pivoting wheels 34, to facilitate towing the implement 10 in the direction of travel 12.

In several embodiments, the tillage implement frame 16 includes a plurality of tillage frame sections. For example, as illustrated in FIG. 1, the tillage implement frame 16 includes a main section 36 positioned centrally between the first and second sides 26, 28 of the frame 16. The tillage implement frame 16 may also include a first wing section 38 that is spaced apart from the main section 36 and positioned proximate to the first side 26 of the frame 16. Similarly, the tillage implement frame 16 may also include a second wing section 40 that is spaced apart from the main section 36 and the first wing section 38 and positioned proximate to the second side 28 of the frame 16. The first and second wing sections 38, 40 may be pivotably coupled to the main section 36 of the frame 16. In this respect, the first and second wing sections 38, 40 may be configured to fold up relative to the main section 36 to reduce the lateral width of the tillage implement 10 to permit, for example, storage or transportation of the implement on a road. However, in alternative embodiments, the tillage implement frame 16 may include any suitable number and/or type of frame sections. For example, in some embodiments, the tillage implement 10 may have additional wing sections, such that the implement 10 has a total of five, seven, or nine frame sections.

Furthermore, the tillage implement frame 16 is configured to support a plurality of tillage tools thereon. For example, in some embodiments, the tillage implement frame 16 may be configured to support a cultivator 42, which may be configured to till or otherwise break the soil over which the implement 10 travels to create a seedbed. In this respect, the cultivator 42 may include a plurality of ground-engaging shanks 44, which are pulled through the soil as the implement 10 moves across the field in the direction of travel 12. In one embodiment, the ground-engaging shanks 44 may be configured to be pivotably mounted to the tillage implement frame 16 to allow the ground-engaging shanks 44 to pivot out of the way of rocks or other impediments in the soil.

Moreover, as shown, the tillage implement 10 also includes one or more harrows 46. In general, the harrow(s) 46 may be configured to be pivotably coupled to the tillage implement frame 16. The harrow(s) 46 may include a plurality of ground-engaging elements 48, such as tines or spikes, which level or otherwise flatten any windrows or ridges in the soil created by the cultivator 42. Specifically, the ground-engaging elements 48 are configured to be pulled through the soil as the tillage implement 10 moves across the field in the direction of travel 12. The implement 10 may include any suitable number of harrows 46.

Moreover, in some embodiments, the tillage implement 10 may include one or more basket assemblies or rotary firming wheels 50. In general, the basket assembly (ies) 50 may be configured to reduce the number of clods in the soil and/or firm the soil over which the tillage implement 10 travels. The basket assembly(ies) 50 is supported on the tillage implement frame 16. For example, as shown, each basket assembly 50 is pivotably coupled to one of the harrows 46, which are, in turn, coupled to the frame 16. Alternatively, the basket assembly(ies) 50 may be configured to be pivotably coupled directly to the frame 16. The implement 10 may include any suitable number of basket assemblies 50 or configurations, such as double baskets.

In addition, one or more sensors may be mounted on or otherwise supported on the tillage implement frame 16. For example, in the illustrated embodiment, a first sensor 102 is supported on the tow bar 14 forward of the main section 36, a second sensor 104 is supported on the first wing section 38, and a third sensor 106 is supported on the second wing section 40. However, in alternative embodiments, any suitable number of sensors may be supported on the tillage implement frame 16. For example, in one alternative embodiment, each frame section may have multiple sensors supported thereon. As will be described below, the sensors 102, 104, 106 are configured to generate data indicative of one or more field characteristics of the field. The generated data is, in turn, used to independently control the operation of the tillage tools supported on each frame section 36, 38, 40.

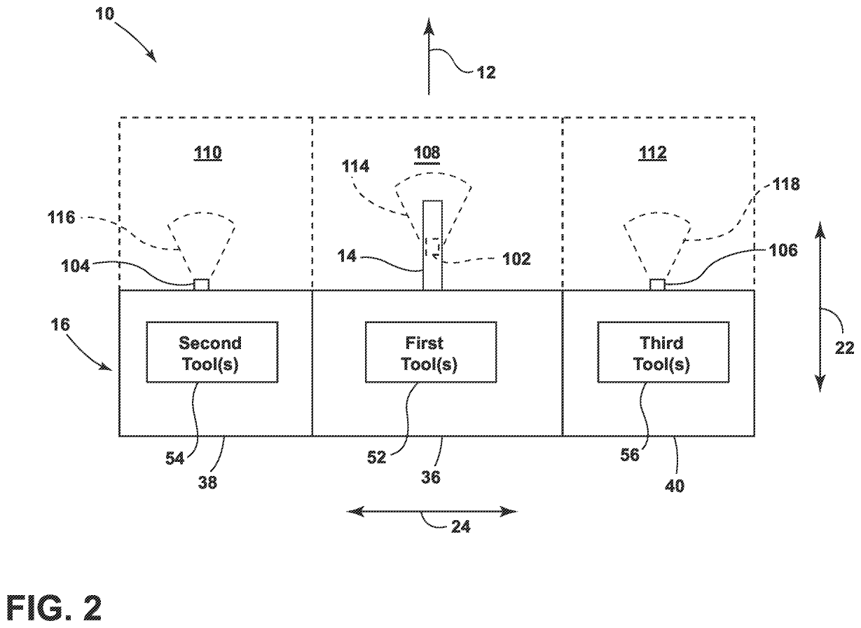

FIG. 2 illustrates a schematic, top-down view of the tillage implement 10. As mentioned above, the tillage implement frame 16 includes the main section 36, the first wing section 38, and the second wing section 40. In this respect, as the tillage implement 10 travels or is otherwise moved across a field to perform a tillage operation thereon, the main section 36 is configured to be moved across a first portion 108 of the field, the first wing section 38 is configured to be moved across a second portion 110 of the field, and the second wing section 40 is configured to be moved across a third portion 112 of the field. The first, second, and third portions 108, 110, 112 of the field are spaced apart from each in the lateral direction 24. That is, as the tillage implement 10 makes a pass across the field, each frame section 36, 38, 40 travels across a different lateral swath or portion of the field.

Additionally, as mentioned above, the tillage implement frame 16 is configured to support a plurality of tillage tools thereon. For example, in the illustrated embodiment, the main section 36 is configured to support a tillage first tool(s) 52 (e.g., a first set of the shanks 44 and/or the basket assemblies 50) thereon. Moreover, in the illustrated embodiment, the first wing section 38 is configured to support a second tillage tool(s) 54 (e.g., a second set of the shanks 44 and/or the basket assemblies 50) thereon. In addition, in the illustrated embodiment, the second wing section 40 is configured to support a third tillage tool(s) 56 (e.g., a third set of the shanks 44 and/or the basket assemblies 50) thereon. However, in alternative embodiments, any other suitable tillage tools may be supported on the different frame sections.

Furthermore, as indicated above, the tillage implement 10 includes the first sensor 102. In general, the first sensor 102 is configured to generate data indicative of a field characteristic within the first portion 108 of the field. As such, the first sensor 102 may be positioned at any suitable location such that the first sensor 102 has a field of view 114 directed at the first portion 108 of the field. For example, in the illustrated embodiment, the first sensor 102 is positioned on the tow bar 14. However, in alternative embodiments, the first sensor 102 may be positioned at the forward end of the main section 36 of the frame 16, at the forward end of the work vehicle (not shown) towing the tillage implement 10, at the aft end of the main section 36, and/or the like.

Additionally, as indicated above, the tillage implement 10 includes the second sensor 104. In general, the second sensor 104 is configured to generate data indicative of a field characteristic within the second portion 110 of the field. As such, the second sensor 104 may be positioned at any suitable location such that the second sensor 104 has a field of view 116 directed at the second portion 110 of the field. For example, in the illustrated embodiment, the second sensor 104 is positioned at the forward end of the first wing section 38 of the frame 16. However, in alternative embodiments, the second sensor 104 may be positioned at any other suitable location, such as at the aft end of first wing section 38.

Moreover, as indicated above, the tillage implement 10 includes the third sensor 106. In general, the third sensor 106 is configured to generate data indicative of a field characteristic within the third portion 112 of the field. As such, the third sensor 106 may be positioned at any suitable location such that the third sensor 106 has a field of view 118 directed at the third portion 112 of the field. For example, in the illustrated embodiment, the third sensor 106 is positioned at the forward end of the second wing section 40 of the frame 16. However, in alternative embodiments, the third sensor 106 may be positioned at any other suitable location.

In several embodiments, the first, second, and third sensors 102, 104, 106 may be soil moisture sensors. In such embodiments, the first, second, and third sensor 102, 104, 106 are configured to capture data indicative of the soil moisture content of the corresponding sections of the field. For example, in such embodiments, the first, second, and third sensors 102, 104, 106 may be non-contact-based sensors, such as cameras, infrared sensors, ground-penetrating radar (GPR) sensors, and/or the like.

Furthermore, in several embodiments, the first, second, and third sensors 102, 104, 106 may be soil compaction sensors. In such embodiments, the first, second, and third sensors 102, 104, 106 are configured to capture data indicative of the presence of a subsurface soil compaction layer within the corresponding sections of the field. For example, in such embodiments, the first, second, and third sensors 102, 104, 106 may be non-contact-based sensors, such as ground-penetrating radar (GPR) sensors, electromagnetic interference (EMI) sensors, and/or the like.

Additionally, in several embodiments, the first, second, and third sensors 102, 104, 106 may be soil type sensors. In such embodiments, the first, second, and third sensors 102, 104, 106 are configured to capture data indicative of the soil type present within the corresponding sections of the field. For example, in such embodiments, the first, second, and third sensors 102, 104, 106 may be non-contact-based sensors, such as cameras, ground-penetrating radar (GPR) sensors, and/or the like.

Moreover, in several embodiments, the first, second, and third sensors 102, 104, 106 may be soil texture sensors. In such embodiments, the first, second, and third sensors 102, 104, 106 are configured to capture data indicative of the soil texture (e.g., sandy soil, loamy soil, silty soil, etc.) present within the corresponding sections of the field. For example, in such embodiments, the first, second, and third sensors 102, 104, 106 may be non-contact-based sensors, such as cameras, ground-penetrating radar (GPR) sensors, gamma ray sensors, and/or the like.

In addition, in several embodiments, the first, second, and third sensors 102, 104, 106 may be residue sensors. In such embodiments, the first, second, and third sensors 102, 104, 106 are configured to capture data indicative of the residue present within the corresponding sections of the field. For example, in such embodiments, the first, second, and third sensors 102, 104, 106 may be non-contact-based sensors, such as cameras and/or the like.

In alternative embodiments, the first, second, and third sensor 102, 104, 106 may be configured to capture data indicative of any other suitable field characteristic or parameter present within the corresponding sections of the field.

Although FIGS. 1 and 2 show a single first sensor 102, a single second sensor 104, and a single third sensor 106, the tillage implement 10 (and/or the associated work vehicle (not shown)) may include multiple first sensors 102, multiple second sensors 104, and/or multiple third sensors 106. For example, in one embodiment, a pair of first sensors 102 may be mounted on the tow bar 14, a pair of second sensors 104 may be mounted on the first wing section 38, and a pair of third sensors 106 may be mounted on the second wing section 40.

In addition, a single first sensor 102, a single second sensor 104, and/or a single third sensor 106 may capture data indicative of multiple field characteristics. For example, in one embodiment, the first sensor 102, the second sensor 104, and the third sensor 106 are configured as cameras that generate image data indicative of the soil type of, the soil texture of, the soil moisture content of, and the residue present within the corresponding portions of the field.

It should be appreciated that the configuration of the tillage implement 10 described above and shown in FIGS. 1 and 2 is provided only to place the present subject matter in an exemplary field of use. Thus, it should be appreciated that the present subject matter may be readily adaptable to any manner of tillage implement configuration.

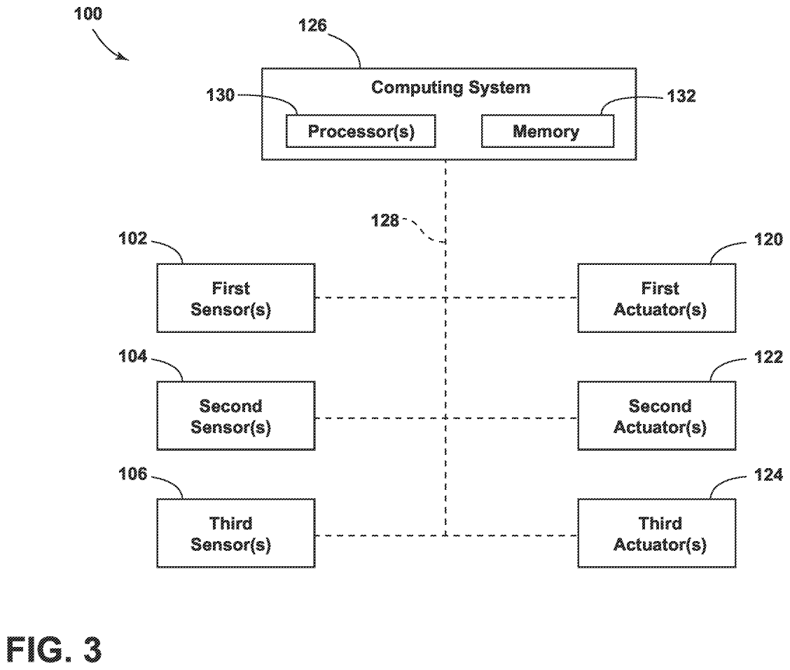

Referring now to FIG. 3, a schematic view of one embodiment of a system 100 for controlling an operation of a tillage implement is illustrated in accordance with aspects of the present subject matter. In general, the system 100 will be described herein with reference to the tillage implement 10 described above with reference to FIGS. 1 and 2. However, it should be appreciated by those of ordinary skill in the art that the disclosed system 100 may generally be utilized with tillage implements having any other suitable tillage implement configuration.

As shown in FIG. 3, the system 100 includes the first sensor(s) 102, the second sensor(s) 104, and third sensor(s) 106.

Furthermore, the system 100 includes one or more first actuators 120 of the tillage implement 10. In general, the first actuator(s) 120 is configured to adjust one more operating parameters of the first tillage tool(s) 52 on the center section 36 of the tillage implement frame 16. For example, the first actuator(s) 120 may adjust the penetration depth of, and/or the force being applied to the first tillage tool(s) 52 (e.g., the penetration depth of or and/or the force being applied to the shank(s) 44 and/or the force being applied to the basket assembly(ies) 50). As such, the first actuator(s) 120 may be configured as a hydraulic cylinder(s), a pneumatic cylinder(s), an electric linear actuator(s), and/or the like.

Additionally, the system 100 includes one or more second actuators 122 of the tillage implement 10. In general, the second actuator(s) 122 is configured to adjust one more operating parameters of the second tillage tool(s) 54 on the first wing section 38 of the tillage implement frame 16. For example, the second actuator(s) 122 may adjust the penetration depth of, or and/or the force being applied to the second tillage tool(s) 54 (e.g., the penetration depth of or and/or the force being applied to the shank(s) 44 and/or the force being applied to the basket assembly(ies) 50). As such, the second actuator(s) 122 may be configured as a hydraulic cylinder(s), a pneumatic cylinder(s), an electric linear actuator(s), and/or the like.

Moreover, the system 100 includes one or more third actuators 124 of the tillage implement 10. In general, the third actuator(s) 124 is configured to adjust one more operating parameters of the third tillage tool(s) 56 on the second wing section 40 of the tillage implement frame 16. For example, the third actuator(s) 124 may adjust the penetration depth of or and/or the force being applied to the third tillage tool(s) 56 (e.g., the penetration depth of or and/or the force being applied to the shank(s) 44 and/or the force being applied to the basket assembly(ies) 50). As such, the third actuator(s) 124 may be configured as a hydraulic cylinder(s), a pneumatic cylinder(s), an electric linear actuator(s), and/or the like.

The first actuator(s) 120, the second actuator(s) 122, and/or the third actuator(s) 124 are independently controllable. In this respect, and as will be described below, the first actuator(s) 120 is configured to adjust the operating parameter(s) of the first tillage tool(s) 52 based on the field characteristics present within first portion 108 of the field and independently of the second tillage tool(s) 54 and the third tillage tool(s) 56. Similarly, the second actuator(s) 122 is configured to adjust the operating parameter(s) of the second tillage tool(s) 54 based on the field characteristics present within second portion 110 of the field and independently of the first tillage tool(s) 52 and the third tillage tool(s) 56. Moreover, the third actuator(s) 124 is configured to adjust the operating parameter(s) of the third tillage tool(s) 56 based on the field characteristics present within third portion 112 of the field and independently of the first tillage tool(s) 52 and the second tillage tool(s) 54.

In alternative embodiment, the system 100 may include any other suitable actuators in addition to or in lieu of the first actuator(s) 120, the second actuator(s) 122, and/or the third actuator(s) 124.

In addition, the system 100 includes a computing system 126 communicatively coupled to one or more components of the tillage implement 10, an associated work vehicle (not shown), and/or the system 100 to allow the operation of such components to be electronically or automatically controlled by the computing system 126. For instance, the computing system 126 may be communicatively coupled to the first, second, and/or third sensors 102, 104, 106 via a communicative link 128. As such, the computing system 126 may be configured to receive data from the first, second, and/or third sensors 102, 104, 106 that is indicative of one or more field characteristics of the field across which the tillage implement 10 is traveling. Furthermore, the computing system 126 may be communicatively coupled to the first, second, and/or third actuators 120, 122, 124 via the communicative link 128. In this respect, the computing system 126 may be configured to control the operation of the first, second, and/or third actuators 120, 122, 124 to independently adjust the operating parameter(s) of the tillage tool(s) supported on each section of the tillage implement frame 16. In addition, the computing system 126 may be communicatively coupled to any other suitable components of the tillage implement 10, the associated work vehicle, and/or the system 100.

In general, the computing system 126 may comprise one or more processor-based devices, such as a given controller or computing device or any suitable combination of controllers or computing devices. Thus, in several embodiments, the computing system 126 may include one or more processor(s) 130 and associated memory device(s) 132 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 132 of the computing system 126 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 132 may generally be configured to store suitable computer-readable instructions that, when implemented by the processor(s) 130, configure the computing system 126 to perform various computer-implemented functions, such as one or more aspects of the methods and algorithms that will be described herein. In addition, the computing system 126 may also include various other suitable components, such as a communications circuit or module, one or more input/output channels, a data/control bus and/or the like.

The various functions of the computing system 126 may be performed by a single processor-based device or may be distributed across any number of processor-based devices, in which instance such devices may be considered to form part of the computing system 126. For instance, the functions of the computing system 126 may be distributed across multiple application-specific controllers or computing devices, such as a navigation controller, an engine controller, a transmission controller, a tillage implement controller, and/or the like.

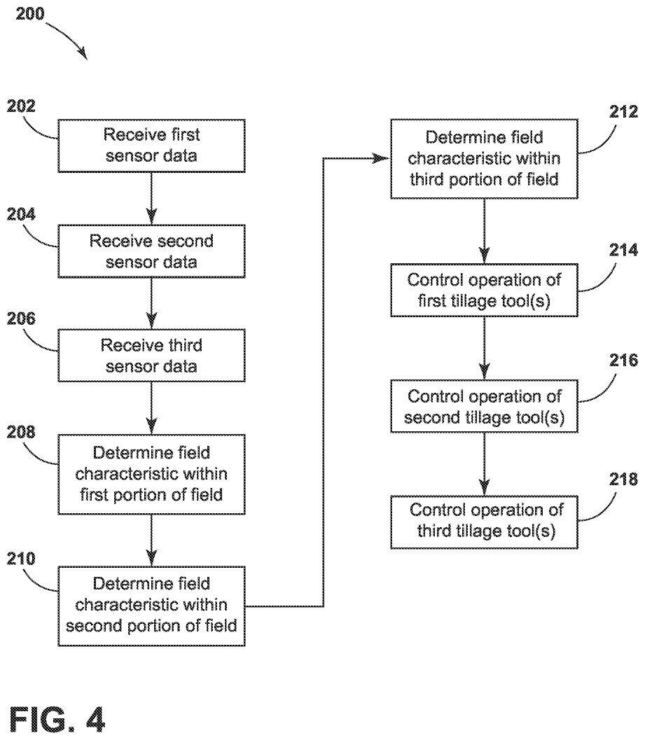

Referring now to FIG. 4, a flow diagram of one embodiment of an example control logic 200 that may be executed by the computing system 126 (or any other suitable computing system) for controlling the operation of a tillage implement is illustrated in accordance with aspects of the present subject matter. Specifically, the control logic 200 shown in FIG. 4 is representative of steps of one embodiment of an algorithm that can be executed to control the operation of a tillage implement in a manner that independently controls the operating parameters of each group of tools on the tillage implement across the width of the implement based on the specific field conditions that will be encountered by those tools. Thus, in several embodiments, the control logic 200 may be advantageously utilized in association with a system installed on or forming part of a tillage implement or an associated work vehicle to allow for real-time control of the tillage implement without requiring substantial computing resources and/or processing time. However, in other embodiments, the control logic 200 may be used in association with any other suitable system, application, and/or the like for controlling the operation of a tillage implement.

As shown, at (202), the control logic 200 includes receiving first sensor data indicative of a field characteristic within a first portion of the field across which a tillage implement is being moved. Specifically, as mentioned above, in several embodiments, the computing system 126 may be communicatively coupled to the first sensor(s) 102 via the communicative link 128. In this respect, as the tillage implement 10 travels across the field to perform a tillage operation thereon, the computing system 126 may receive first sensor data from the first sensor(s) 102. Such first sensor data may, in turn, be indicative of one or more field conditions within the first portion of the field across which a first section (e.g., the center section 36) of the tillage implement frame 16 is being moved.

Furthermore, at (204), the control logic 200 includes receiving second sensor data indicative of a field characteristic within a second portion of the field across which the tillage implement is being moved. Specifically, as mentioned above, in several embodiments, the computing system 126 may be communicatively coupled to the second sensor(s) 104 via the communicative link 128. In this respect, as the tillage implement 10 travels across the field to perform the tillage operation, the computing system 126 may receive second sensor data from the second sensor(s) 104. Such second sensor data may, in turn, be indicative of one or more field conditions within the second portion of the field across which a second section (e.g., the first wing section 38) of the tillage implement frame 16 is being moved.

Additionally, at (206), the control logic 200 includes receiving third sensor data indicative of a field characteristic within a third portion of the field across which the tillage implement is being moved. Specifically, as mentioned above, in several embodiments, the computing system 126 may be communicatively coupled to the third sensor(s) 106 via the communicative link 128. In this respect, as the tillage implement 10 travels across the field to perform the tillage operation, the computing system 126 may receive third sensor data from the third sensor(s) 106. Such third sensor data may, in turn, be indicative of one or more field conditions within the third portion of the field across which a third section (e.g., the second wing section 40) of the tillage implement frame 16 is being moved.

Moreover, at (208), the control logic 200 includes determining the field characteristic within the first portion of the field based on the received first sensor data. Specifically, in several embodiments, the computing system 126 is configured to analyze the first sensor data received at (202) to determine one or more field characteristics within the first portion of the field. For example, the computing system 126 may include one or more suitable look-up tables stored within its memory device(s) 132 that correlate the received first sensor data to the field characteristic(s) within the first portion of the field.

In addition, at (210), the control logic 200 includes determining the field characteristic within the second portion of the field based on the received second sensor data. Specifically, in several embodiments, the computing system 126 is configured to analyze the second sensor data received at (204) to determine one or more field characteristics within the second portion of the field. For example, the computing system 126 may include one or more suitable look-up tables stored within its memory device(s) 132 that correlate the received second sensor data to the field characteristic(s) within the second portion of the field.

As shown in FIG. 4, at (212), the control logic 200 includes determining the field characteristic within the third portion of the field based on the received third sensor data. Specifically, in several embodiments, the computing system 126 is configured to analyze the third sensor data received at (206) to determine one or more field characteristics within the third portion of the field. For example, the computing system 126 may include one or more suitable look-up tables stored within its memory device(s) 132 that correlate the received third sensor data to the field characteristic(s) within the third portion of the field.

Any suitable field characteristic(s) may be determined at (208), (210), and (212). For example, such field characteristic(s) may include the soil moisture content, the presence of a subsurface soil compaction layer, the soil type, the soil texture, a residue parameter(s) (e.g., residue coverage, residue size, etc.), and/or the like.

Furthermore, the same field characteristic(s) are determined (208), (210), and (212). For example, when soil type and soil texture are determined for the first portion of the field at (208), the soil type and soil texture for the second and third portions of the field are determined at (210) and (212).

Additionally, at (214), the control logic 200 includes controlling the operation of a first tillage tool based on the determined field characteristic within the first portion of the field and independently of a second tillage tool and a third tillage tool. Specifically, in several embodiments, the computing system 126 is configured to control the operation of the first tillage tool(s) 52 supported on the center section 36 of the frame 16 based on the field characteristic(s) within the first portion of the field determined at (208) and independently of the second and third tillage tools 54, 56. For example, the computing system 126 may transmit suitable control signals to the first actuator(s) 120 via the communicative link 128. Such control signals, in turn, instruct the first actuator(s) 120 to adjust one or more operating parameters of (e.g., the penetration depth of and/or the force being applied to) the first tillage tool(s) 52.

Moreover, at (216), the control logic 200 includes controlling the operation of a second tillage tool based on the determined field characteristic within the second portion of the field and independently of the first tillage tool and the third tillage tool. Specifically, in several embodiments, the computing system 126 is configured to control the operation of the second tillage tool(s) 54 supported on the first wing section 38 of the frame 16 based on the field characteristic(s) within the second portion of the field determined at (210) and independently of the first and third tillage tools 52, 56. For example, the computing system 126 may transmit suitable control signals to the second actuator(s) 122 via the communicative link 128. Such control signals, in turn, instruct the second actuator(s) 122 to adjust one or more operating parameters of (e.g., the penetration depth of and/or the force being applied to) the second tillage tool(s) 54.

In addition, at (218), the control logic 200 includes controlling the operation of a third tillage tool based on the determined field characteristic within the third portion of the field and independently of the first tillage tool and the second tillage tool. Specifically, in several embodiments, the computing system 126 is configured to control the operation of the third tillage tool(s) 56 supported on the second wing section 40 of the frame 16 based on the field characteristic(s) within the third portion of the field determined at (212) and independently of the first and third tillage tools 52, 54. For example, the computing system 126 may transmit suitable control signals to the third actuator(s) 124 via the communicative link 128. Such control signals, in turn, instruct the third actuator(s) 124 to adjust one or more operating parameters of (e.g., the penetration depth of and/or the force being applied to) the third tillage tool(s) 56.

The particular operating parameter adjustments made at (214), (216), and (218) are based on the particular field conditions determined at (208), (210), and (212). For example, when the soil moisture content within one portion of the field exceeds a maximum value, the force being applied to the tillage tool(s) supported on the corresponding frame section is decreased. Conversely, when the soil moisture content within one portion of the field falls below a minimum value, the force being applied to the tillage tool(s) supported on the corresponding frame section is increased.

The control logic 200 is described in context of determining a field characteristic(s) that will be encountered by the tillage tools on three sections of the tillage frame 16 and independently controlling the tillage tools on the three frame sections. However, in alternative embodiments, the control logic 200 may include determining a field characteristic(s) that will be encountered by the tillage tools on more or fewer sections of the tillage frame 16 (e.g., two sections or three or more sections) and independently controlling the tillage tools on these frame sections.

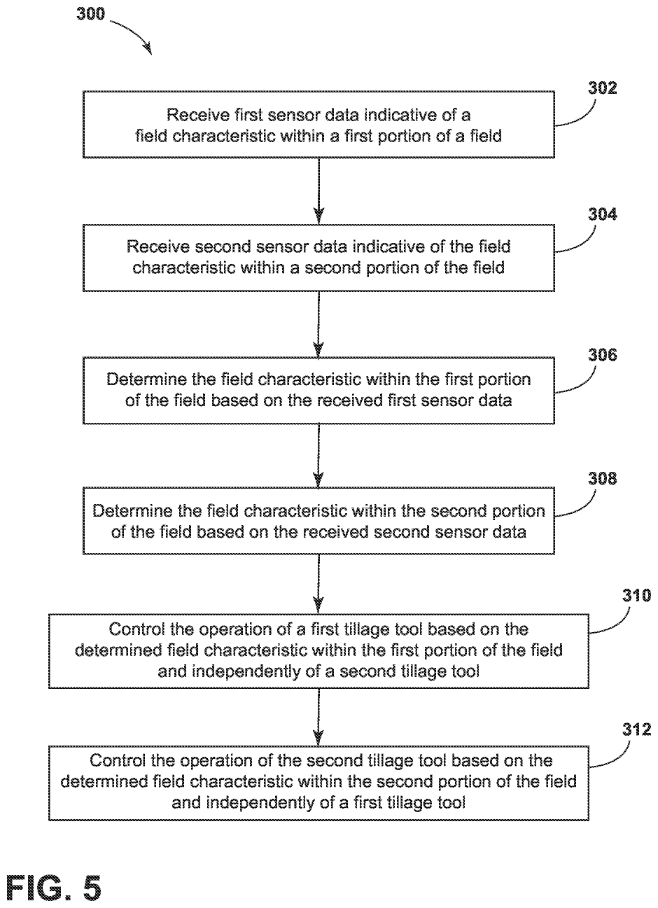

Referring now to FIG. 5, a flow diagram of one embodiment of a method 300 for controlling the operation of a tillage implement is illustrated in accordance with aspects of the present subject matter. In general, the method 300 will be described herein with reference to the tillage implement 10 and the system 100 described above with reference to FIGS. 1-4. However, it should be appreciated by those of ordinary skill in the art that the disclosed method 300 may generally be implemented with any tillage implement having any suitable implement configuration and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 includes receiving, with a computing system, first sensor data indicative of a field characteristic within the first portion of the field. For instance, as described above, the computing system 126 may be configured to receive first sensor data from the first sensor(s) 102 via the communicative link 128. The first sensor data is, in turn, indicative of one or more field characteristics within a first portion of the field.

Furthermore, at (304), the method 300 includes receiving, with the computing system, second sensor data indicative of the field characteristic within the second portion of the field. For instance, as described above, the computing system 126 may be configured to receive second sensor data from the second sensor(s) 104 via the communicative link 128. The second sensor data is, in turn, indicative of one or more field characteristics within a second portion of the field.

Additionally, at (306), the method 300 includes determining, with the computing system, the field characteristic within the first portion of the field based on the received first sensor data. For instance, as described above, the computing system 126 may be configured to determine the field characteristic within the first portion of the field based on the received first sensor data.

Moreover, at (308), the method 300 includes determining, with the computing system, the field characteristic within the second portion of the field based on the received second sensor data. For instance, as described above, the computing system 126 may be configured to determine the field characteristic within the second portion of the field based on the received second sensor data.

In addition, at (310), the method 300 includes controlling, with the computing system, the operation of a first tillage tool based on the determined field characteristic within the first portion of the field and independently of a second tillage tool. For instance, as described above, the computing system 126 may be configured to control the operation of the first tillage tool(s) 52 based on the determined field characteristic within the first portion of the field and independently of the second tillage tool(s) 54.

Furthermore, at (312), the method 300 includes controlling, with the computing system, the operation of a second tillage tool based on the determined field characteristic within the second portion of the field and independently of a first tillage tool. For instance, as described above, the computing system 126 may be configured to control the operation of the second tillage tool(s) 54 based on the determined field characteristic within the second portion of the field and independently of the first tillage tool(s) 52.

It is to be understood that the steps of the control logic 200 and the method 300 are performed by the computing system 126 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 126 described herein, such as the control logic 200 and the method 300, is implemented in software code or instructions which are tangibly stored on a tangible computer readable medium. The computing system 126 loads the software code or instructions via a direct interface with the computer readable medium or via a wired and/or wireless network. Upon loading and executing such software code or instructions by the computing system 126, the computing system 126 may perform any of the functionality of the computing system 126 described herein, including any steps of the control logic 200 and the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A tillage implement, comprising:
a frame extending in a lateral direction between a first side of the frame and a second side of the frame, the frame including a first frame section configured to be moved across a first portion of a field, the frame further including a second frame section spaced apart from the first frame section in the lateral direction, the second frame section configured to be moved across a second portion of the field;
a first tillage tool supported on the first frame section;
a second tillage tool supported on the second frame section;
a first sensor configured to generate data indicative of a field characteristic within the first portion of the field;
a second sensor configured to generate data indicative of the field characteristic within the second portion of the field; and
a computing system communicatively coupled to the first sensor and the second sensor, the computing system configured to:
determine the field characteristic within the first portion of the field based on the data generated by the first sensor;
determine the field characteristic within the second portion of the field based on the data generated by the second sensor;
control an operation of the first tillage tool based on the determined field characteristic within the first portion of the field and independently of the second tillage tool; and
control an operation of the second tillage tool based on the determined field characteristic within the second portion of the field and independently of the first tillage tool.

2. The tillage implement of claim 1, wherein the first tillage tool comprises a first shank and the second tillage tool comprises a second shank.

3. The tillage implement of claim 2, wherein:
when controlling the operation of the first tillage tool, the computing system is configured to control at least one of a penetration depth of or a force being applied to the first shank; and
when controlling the operation of the second tillage tool, the computing system is configured to control at least one of a penetration depth of or a force being applied to the second shank.

4. The tillage implement of claim 1, wherein the first tillage tool comprises a first basket assembly and the second tillage tool comprises a second basket assembly.

5. The tillage implement of claim 4, wherein:
when controlling the operation of the first tillage tool, the computing system is configured to control a force being applied to the first basket assembly; and
when controlling the operation of the second tillage tool, the computing system is configured to control a force being applied to the second basket assembly.

6. A system for controlling an operation of a tillage implement, the system comprising:
a tillage implement frame extending in a lateral direction between a first side of the tillage implement frame and a second side of the tillage implement frame, the frame including a first tillage implement frame section configured to be moved across a first portion of a field, the tillage implement frame further including a second tillage implement frame section spaced apart from the first tillage implement frame section in the lateral direction, the second tillage implement frame section configured to be moved across a second portion of the field;
a first tillage tool supported on the first tillage implement frame section;
a second tillage tool supported on the second tillage implement frame section;
a first sensor configured to generate data indicative of a field characteristic within the first portion of the field;
a second sensor configured to generate data indicative of the field characteristic within the second portion of the field; and
a computing system communicatively coupled to the first sensor and the second sensor, the computing system configured to:
determine the field characteristic within the first portion of the field based on the data generated by the first sensor;
determine the field characteristic within the second portion of the field based on the data generated by the second sensor;
control an operation of the first tillage tool based on the determined field characteristic within the first portion of the field and independently of the second tillage tool; and
control an operation of the second tillage tool based on the determined field characteristic within the second portion of the field and independently of the first tillage tool.

7. The system of claim 6, wherein the first tillage tool comprises a first shank and the second tillage tool comprises a second shank.

8. The system of claim 7, wherein:
when controlling the operation of the first tillage tool, the computing system is configured to control at least one of a penetration depth of or a force being applied to the first shank; and
when controlling the operation of the second tillage tool, the computing system is configured to control at least one of a penetration depth of or a force being applied to the second shank.

9. The system of claim 6, wherein the first tillage tool comprises a first basket assembly and the second tillage tool comprises a second basket assembly.

10. The system of claim 9, wherein:
when controlling the operation of the first tillage tool, the computing system is configured to control a force being applied to the first basket assembly; and
when controlling the operation of the second tillage tool, the computing system is configured to control a force being applied to the second basket assembly.

11. The system of claim 6, wherein the field characteristic comprises a soil moisture content.

12. The system of claim 6, wherein the field characteristic comprises a presence of a subsurface soil compaction layer.

13. The system of claim 6, wherein the field characteristic comprises a soil type.

14. The system of claim 6, wherein the field characteristic comprises a soil texture.

15. The system of claim 6, wherein the field characteristic comprises a residue parameter.

16. The system of claim 6, wherein:
the first portion of the field is positioned forward of the first tillage implement frame section relative to a direction of travel of the tillage implement; and
the second portion of the field is positioned forward of the second tillage implement frame section relative to the direction of travel.

17. A method for controlling an operation of a tillage implement, the tillage implement including a first tillage implement frame section configured to be moved across a first portion of a field, a first tillage tool supported on the first tillage implement frame section, a second tillage implement frame section configured to be moved across a second portion of the field, and a second tillage tool supported on the second tillage implement frame section, the method comprising:
receiving, with a computing system, first sensor data indicative of a field characteristic within the first portion of the field;
receiving, with the computing system, second sensor data indicative of the field characteristic within the second portion of the field;
determining, with the computing system, the field characteristic within the first portion of the field based on the received first sensor data;
determining, with the computing system, the field characteristic within the second portion of the field based on the received second sensor data;
controlling, with the computing system, an operation of the first tillage tool based on the determined field characteristic within the first portion of the field and independently of the second tillage tool; and
controlling, with the computing system, an operation of the second tillage tool based on the determined field characteristic within the second portion of the field and independently of the first tillage tool.

18. The method of claim 17, wherein the field characteristic comprises a soil moisture content.

19. The method of claim 17, wherein the field characteristic comprises a presence of a subsurface soil compaction layer.

20. The method of claim 17, wherein the field characteristic comprises a soil type.
